(19) United States
(12) Patent Application Publication
(10) Pub. No.: US 2013/0136362 A1
(43) Pub. Date: May 30, 2013

(54) IMAGE PROCESSING METHOD

(71) Applicant: NOVATEK MICROELECTRONICS CORP., Hsinchu (TW)

(72) Inventors: Guang-Zhi Liu, Shanghai (CN); Lei Zhou, Shanghai (CN); Jian-De Jiang, Shaanxi (CN)

(73) Assignee: NOVATEK MICROELECTRONICS CORP., Hsinchu (TW)

(21) Appl. No.: 13/684,153

(22) Filed: Nov. 21, 2012

(30) Foreign Application Priority Data
Nov. 29, 2011 (CN) 201110386316.5

(51) Int. Cl. G06K 9/46

(52) U.S. Cl. CPC G06K 9/46
USPC 382/190

(57) ABSTRACT

An image processing method for processing an interleaved image is disclosed. A reference window and direction windows matched to the reference window are set with respect to known pixel rows in the interleaved image. First parameters along candidate directions of the reference window is calculated, wherein the first parameters denote pixel differences between the reference window and the direction windows. A respective first direction, among direction groups of the candidate directions and corresponding to a minimum of the first parameters, is found. First and/or second portion direction of first and second portions of the interleaved image are found among the first directions. The first and the second portions of the interleaved image are identified according to the first parameters. A center pixel of the reference window is obtained by interpolation according to the first and the second portion directions.

This application claims the benefit of People's Republic of China application Serial No. 201110386316.5, filed Nov. 29, 2011, the subject matter of which is incorporated herein by reference.

### BACKGROUND

1. Technical Field

The disclosure relates in general to an image processing method.

2. Description of the Related Art

There are ways for displaying motion images on a display, namely, progressive scanning and interlaced scanning. In the progressive scanning, which is also referred as row by row scanning, all pixels of a frame are sequentially displayed from left to right and top to down. In the interlaced scanning, which is also referred as alternate scanning, pixels of an image are divided two fields: one field includes pixels in odd rows the other field includes pixels in even rows. The field formed by odd rows and the field formed by even rows are scanned in an alternate sequence. Since a field includes half pixels of a frame, interlaced scanning reduces data size while maintains the same refresh rate.

New generation display apparatus, fast enough to process and scan an entire frame in a real-time manner, basically implement the progressive scanning. However, severe flicker phenomenon will occur and the display brightness will be halved if interleaved images are displayed on the new generation display apparatus. Due to the above problems, new generation of display apparatus implementing progressive scanning are equipped with the de-interlacing function.

The de-interlacing function is for converting an interlacing image signal into a progressive image signal.

The de-interlacing can further be divided into two categories: motion dependent inter-field de-interlacing and motion independent intra-field de-interlacing. The motion independent intra-field de-interlacing has lower implementation cost, and interpolates a pixel row according to existing pixel rows along possible object directions. The conventional edge-based line-averaging (ELA) algorithm is based on this but cannot predict the correct object direction.

However, the de-interlacing algorithm may have the following disadvantages: the interpolated image at the intersection at object corner and at image edge may be unsmooth; sawtooth effect may occur at low-angle edges; and the direction detection in the high-frequency portion of an image may be incorrect.

### SUMMARY OF THE DISCLOSURE

The disclosure is directed to an image processing method, which performs window measurement on pixel rows by adaptive searching window width, to predict an edge direction.

The disclosure is directed to an image processing method which detects a high-frequency portion of an image and interpolates pixels by multi-directional selection.

According to an exemplary embodiment of the present disclosure, an image processing method for processing an interleaved image is disclosed. A reference window and direction windows matched to the reference window are set with respect to known pixel rows in the interleaved image. First parameters along candidate directions of the reference window is calculated, wherein the first parameters denote pixel differences between the reference window and the direction windows. A respective first direction, among direction groups of the candidate directions and corresponding to a minimum of the first parameters, is found. First and/or second portion direction of first and second portions of the interleaved image are found among the first directions. The first and the second portions of the interleaved image are identified according to the first parameters. A center pixel of the reference window is obtained by interpolation according to the first and the second portion directions.

The above and other contents of the disclosure will become better understood with regard to the following detailed description of the non-limiting embodiment(s). The following description is made with reference to the accompanying drawings.

### BRIEF DESCRIPTION OF THE DRAWINGS

FIG. 1 shows a flowchart of an image processing method according to an embodiment of the disclosure;

FIG. 2 shows a schematic diagram of edge direction prediction by window matching according to the embodiment of the disclosure;

FIG. 3 shows a number of directions corresponding to a minimum SAD according to the embodiment of the disclosure; and

FIGS. 4A-FIG. 4C show the SAD in a low-frequency portion, a periodical portion and a disordered portion respectively.

### DETAILED DESCRIPTION OF THE DISCLOSURE

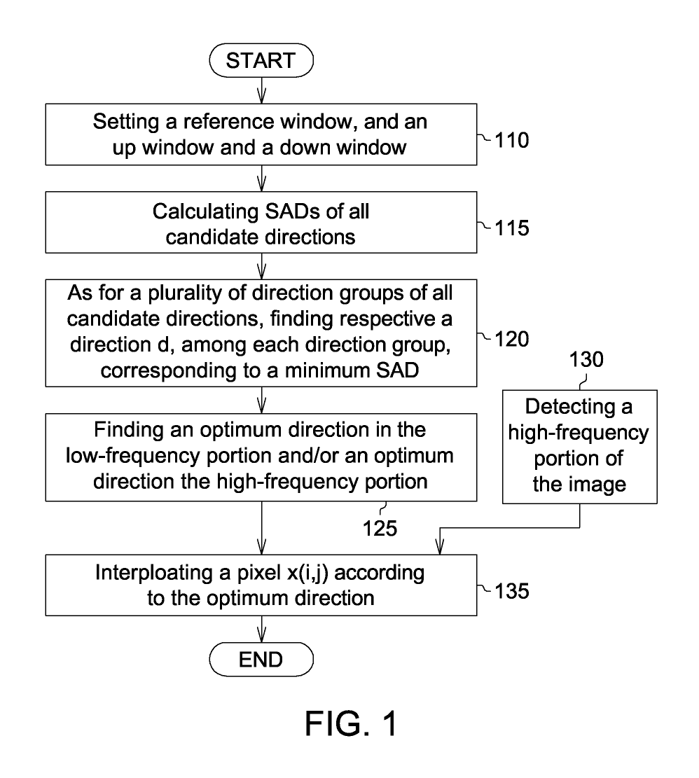

Referring to FIG. 1, a flowchart of an image processing method according to an embodiment of the disclosure is shown. In step 110, a reference window, and an up window and a down window matched to the reference window are set according to parameters d and k, with respect to a plurality of known pixel rows in a frame. The parameter d denotes a shift distance, and the parameter k denotes a window width.

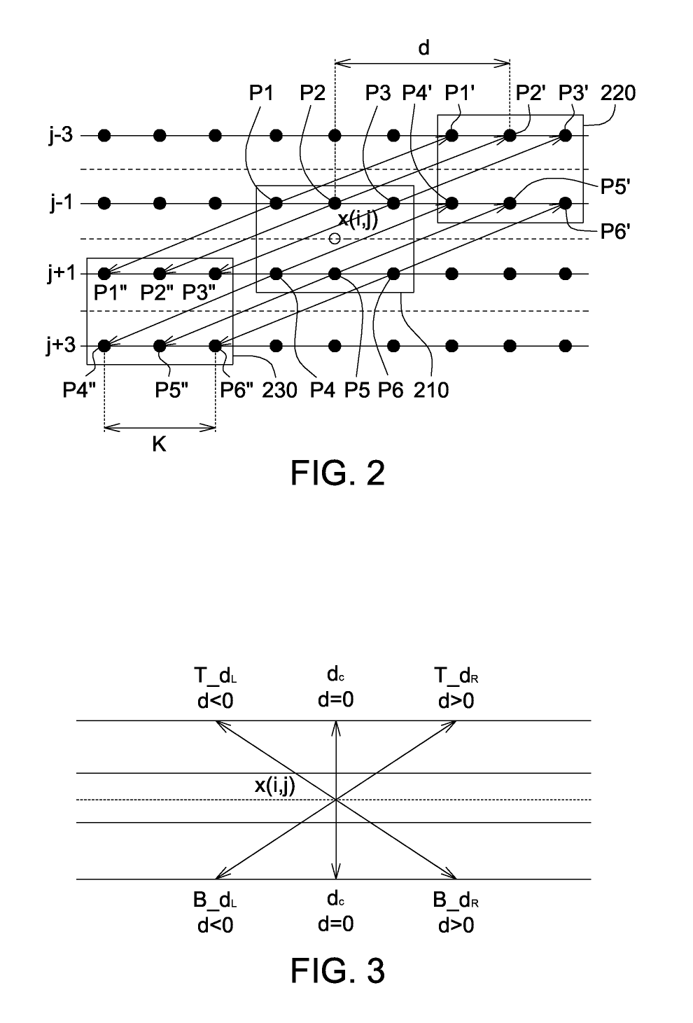

Referring to FIG. 2, a schematic diagram of edge direction prediction by window matching according to the embodiment of the disclosure is shown. As indicated in FIG. 2, a pixel x(i,j) denotes a to-be-interpolated pixel. The known pixel rows j+3, j+1, j−1 and j−3 are denoted by solid lines. The unknown pixel rows to be obtained by way of interpolation are denoted by dotted lines. The window 210 denotes a reference window whose center is the to-be-interpolated pixel x(i,j). The window 210 includes n known pixels in the known pixel row j+1 and n known pixels in the known pixel row j−1, wherein n is a positive integral. In the disclosure below, n is exemplified by 3, but the disclosure is not limited thereto. The window 220 denotes an up window, and includes 3 known pixels in the known pixel row j−1 and 3 known pixels in the known pixel row j−3. That is, the up window 220 is located above the to-be-interpolated pixel x(i,j). The window 230 denotes a down window, and includes 3 known pixels in the known pixel row j+1 and 3 known pixels in the known pixel row j+3. That is, the down window 230 is located under the to-be-interpolated pixel x(i,j). In the present embodiment, the measurement is performed on 4 pixel rows, but the disclosure is not limited thereto.

In the present specification, the relative position between the window 210 and the window 220 is that the window 220 is obtained by shifting the window 210 by d pixels. However, the shift is not just a horizontal shift, as seen from FIG. 2. In the present embodiment, the relative position between the windows 220 and 230 is changed by adjusting the parameter d, and the widths of the windows 220 and 230 are changed by adjusting the parameter k.

In step 115, a sum of absolute differences SAD of all candidate directions is calculated. Referring to FIG. 2, the shift parameter d results a relative direction between the window 210 and the window 220. Let FIG. 2 be taken for example. The window 220 is located to the top right of the window 210. The distance between the window 220/230 and the window 210 is related to d. For the window 210, the SAD of all candidate directions is calculated as:

$${SAD}_{top} ( i , j , d ) = \frac{{\sum }_{k} ( \begin{matrix}abs ( x ( i + d + k , j - 3 ) - x ( i + k , j - 1 ) ) + \\ abs ( x ( i + d + k , j - 1 ) - x ( i + k , j + 1 ) )\end{matrix} )}{k} \\ d ∈ Z , k = N * \vert d \vert + 1 N > 1 and ( N mod 2 ) = 0 \\ {D}_{up} = arg min {SAD}_{top} ( i , j , d ) \\ {SAD}_{bottom} ( i , j , d ) = \frac{{\sum }_{k} ( \begin{matrix}abs ( x ( i + d + k , j - 1 ) - x ( i + k , j + 1 ) ) + \\ abs ( x ( i + d + k , j + 1 ) - x ( i + k , j + 3 ) )\end{matrix} )}{k} \\ d ∈ Z , k = N * \vert d \vert + 1 N > 1 and ( N mod 2 ) = 0 \\ {D}_{bottom} = arg min {SAD}_{bottom} ( i , j , d ) \\ k = N * \vert d \vert + 1 N > 1 and ( N mod 2 ) = 0 \qquad ( 1 )$$

As indicated in formula (1), SADtop(i,j,d) and SADdown(i,j,d) respectively denote SAD of an up window (such as the window 220 of FIG. 2 , which is obtained from shifting the reference window by d pixels) and SAD of a down window (such as the window 2e0 of FIG. 2 , which is obtained from shifting the reference window by d pixels). That is, SAD is obtained by, summing absolute differences between the values of 6 pixels of the reference window 210 and the values of 6 corresponding pixels of the window 220 and then dividing the summation by k. In FIG. 2, d and k are exemplified by 3, but the disclosure is not limited thereto. Therefore, SADtop(i,j,d) is obtained by, summing absolute differences between the values of 6 pixels P1˜P6 of the reference window 210 and the values of 6 corresponding pixels P1′˜P6′ of the window 220 and then dividing the summation by 3. Furthermore, the difference between the pixels P1 and P1′ is x(i+2,j−3)−x(i−1,j−1), wherein P1 is x(i−1,j−1) and P1′ is x(i+2,j−3). The difference between the pixels P2 and P2′ is x(i+3,j−3)−x(i,j−1), wherein P2 is x(i,j−1) and P2′ is x(i+3,j−3). The difference between other pixels may be obtained by the same analogy. Likewise, SADdown(i,j,d) is obtained by, summing absolute differences between the values of 6 pixels P1˜P6 of the reference window 210 and the values of 6 corresponding pixel values P1″˜P6″ of the window 230 and then dividing the summation by k.

As indicated in formula (1), k=N*|d|+1, N is a positive integral greater than 1 and N is an even-numbered integral, that is, (N mod 2)=0.

In step 120, a respective direction (d), related to a minimum SAD, in each direction group is found among direction groups of all candidate directions. For example, the candidate directions are grouped into a top right direction group, a top middle direction group, a top left direction group, a bottom right direction group, a bottom middle direction group and a bottom left direction group. The respective d value making SAD a minimum is found among the top right direction group, the top middle direction group, the top left direction group, the bottom right direction group, the bottom middle direction group and the bottom left direction group. The range of d is exemplified by d=(−14˜−1), (0) ,(+1˜+14). The d value within the range of (−14˜−1), which makes SADtop a minimum, is found, and the d value is set as T_dL. That is, the d value among the top left direction group, which is corresponding to the minimum SAD, is found. The d value within the range of (−14˜−1), which makes SADdown a minimum, is found, and the d value is set as B_dL. That is, the d value among the bottom left direction group, which is corresponding to the minimum SAD, is found. The d value within the range of (0), which makes making SADtop a minimum, is found, and the d value is set as dc. In fact, dc=0 because d=0 is the only direction among the middle right direction group. The d value within the range of (0), which makes SADdown a minimum, is found among the range of d=0, and the d value is set as dc. In fact, dc=0 because d=0 is the only direction among the middle left direction group. The d value within the range of (+1˜+14), which makes SADtop a minimum, is found, and the d value is set as T_dR. That is, the d value among the top right direction group, which is corresponding to the minimum SAD, is found. The d value among the range of (+1˜+14), which makes SADdown a minimum, is found, the d value is set as B_dR. That is, the d value among the bottom right direction group, which is corresponding to the minimum SAD, is found.

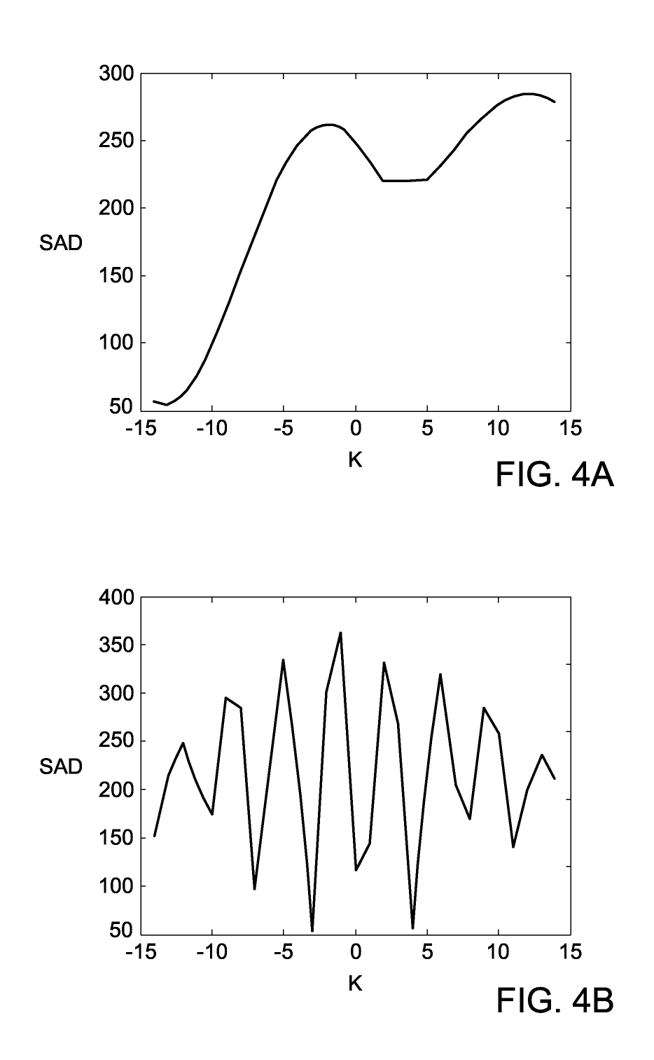

Referring to FIG. 3, a number of directions, i.e. a top right direction T_dR, a top middle direction dc, a top left direction T_dL, a bottom right direction B_dR, a bottom middle direction dc, and a bottom left direction B_dL, which is corresponding to the minimum SAD, according to the embodiment of the disclosure are shown.

In step 125, an optimum direction in the low-frequency portion and/or an optimum direction in the high-frequency portion are found. In the low-frequency (normal) portion, the direction, which makes a minimum SAD, may be selected as the optimum direction. In the high-frequency portion or the periodical portion, the selection of optimum direction is more difficult. In the embodiment of the disclosure, the top right direction T_dR, the top middle direction dc, the top left direction T_dL, the bottom right direction B_dR, the bottom middle direction dc, the bottom left direction B_dL are selected among the candidate directions, as discussed above.

The selection of optimum direction for the high-frequency portion or the periodical portion is disclosed below. If along the optimum direction d (or said the optimum shift d), the minimum SAD is found and sum of the SAD is also small within the range [1,d]. In the embodiment of the disclosure, sum of SAD along the optimum direction is smaller than sum of SAD along non-optimum direction.

In the embodiment of the disclosure, the SAD sum AE along a direction dk is expressed as:

$$AE ( i , j , k ) = \frac{{\sum }_{d = 0}^{d} SAD ( i , j , d )}{k} , {d}_{k} ∈ \{ {d}_{L} , {d}_{C} , {d}_{R} \} , d ∈ \{ 0 , {d}_{k} \} \qquad ( 2 )$$

The SAD sum AE is an indicator for identifying the directions dR, dc and T_dL for the high-frequency portion. This is because the difference between the optimum-direction SAD and the non-optimum direction SAD may be tiny, but AE along the optimum-direction is smaller than AE along the non-optimum direction, and the difference between AE along the optimum-direction and AE along the non-optimum direction may be significant.

As indicated in formula (3), for the high-frequency portion, a top optimum direction T_d is selected among the top right direction T_dR, the top middle direction dc, the top left direction T_dL. For the high-frequency portion, a bottom optimum direction B_d is selected among the bottom right direction B_dR, the bottom middle direction dc, the bottom left direction B_dL:

$$\begin{matrix}T\_d = {arg}_{k} min ( AE ( k ) ) & k ∈ \{ {T\_d}_{L} , {T\_d}_{C} , {T\_d}_{R} \} \\ B\_d = {arg}_{k} min ( AE ( k ) ) & k ∈ \{ {B\_d}_{L} , {B\_d}_{C} , {B\_d}_{R} \}\end{matrix} \qquad ( 3 )$$

That is, the top optimum direction T_d is one of the directions T_dR, dc and T_dL that makes AE a minimum. According to formula (2), 3 AE values corresponding to the directions T_dR, dc and T_dL are respectively calculated, and the direction corresponding to the minimum AE value is defined as the top optimum direction T_d. Likewise, the bottom optimum direction B_d is one of the directions B_dR, dc and B_dL that minimized AE. That is, according to formula (2), 3 AE values corresponding to the directions B _dR, dc and B_dL are respectively calculated, and the direction corresponding to the minimum AE value is defined as the bottom optimum direction B_d.

The optimum direction D_hf for the high-frequency portion is selected according to formula (4):

$$D\_hf = {arg}_{k} min ( SAD ( k ) ) , k ∈ \{ T\_d , B\_d \} \qquad ( 4 )$$

That is, the optimum direction D_hf for the high-frequency portion is one of the directions T_d and B_d that makes AE a minimum. That is, according to formula (2), 2 AE values corresponding to the directions T_d and B_d are respectively calculated, and the direction corresponding to the minimum AE value is defined as the optimum direction D_hf for the high-frequency portion.

The optimum direction D_If for the low-frequency portion is selected according to formula (5):

$$D\_lf = {arg}_{k} min ( SAD ( k ) ) , k ∈ \{ {T\_d}_{L} , {T\_d}_{R} , {d}_{C} , {B\_d}_{L} , {B\_d}_{R} \} \qquad ( 5 )$$

That is, the optimum direction D_If for the low-frequency portion is one of the directions T_dL, T_dR, dC, B_dL and B_dR that makes SAD(k) a minimum. That is, according to formula (1), 5 SAD(k) values corresponding to the directions T_dL, T_dR, dC, B_dL and B_dR are respectively calculated, and the direction corresponding to the minimum SAD(k) value is defined as the optimum direction D_If for the low-frequency portion.

In step 130, the high-frequency portion of the image is detected. The high-frequency portion is such as stripes or regular patterns. For example, the black and white stripes of a zebra may be the high-frequency portion of the image.

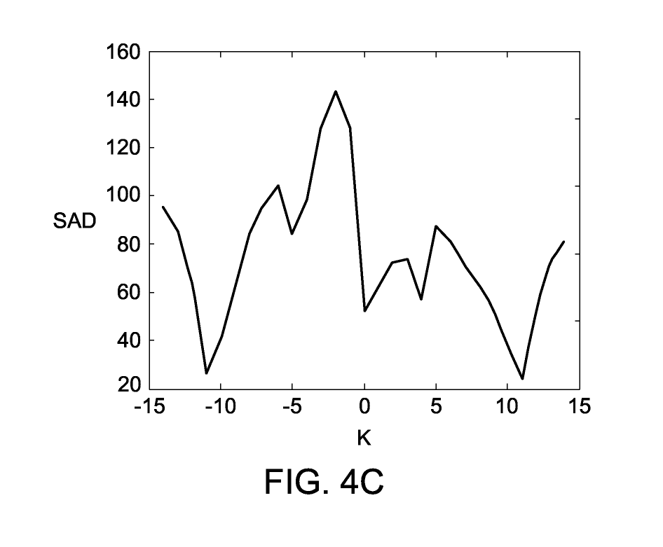

In the embodiment of the disclosure, the high-frequency portion is as a reference to assist the selection of direction. FIG. 4A˜FIG. 4C show the SADs in a low-frequency portion, a periodical portion and a disordered portion respectively.

In the embodiment of the disclosure, the second order differential of SAD denotes a magnitude of oscillation for the high-frequency portion. Basically, the second order differential of SAD for the high-frequency portion is far larger than the second order differential of SAD for the low-frequency portion.

$${SAD}^{′} ( d ) = SAD ( d + 1 ) - SAD ( d ) \\ {SAD}^{″} = {\sum }_{d} \vert {SAD}^{′} ( d + 1 ) - {SAD}^{′} ( d ) \vert \qquad ( 6 )$$

As indicated in formula (6), SAD′(d) denotes a first-order differential of SAD, and SAD″ denotes a second order differential of SAD.

Step 135 interpolates a pixel x(i,j) according to the optimum direction. To put it in greater details, the pixel x(i,j) is obtained by interpolation according to formula (7):

P_{—}hf(i,j)=x(i−D_{—}hf, j−1)+x(i+D_{—}hf, j+1)

P_{—}If(i,j)=x(i−D_{—}If, j−1)+x(i+D_{—}If, j+1)

X(i,j)=(1−α(SAD″))*P_{—}If(i,j)+α(SAD″)*P_{—}hf(i,j) (7)

wherein, α(SAD″)∈[0,1], a denotes a weighting factor obtained from SAD, and the larger the α, the larger likelihood the pixel is in the high-frequency portion.

That is, the pixel x(i,j) is obtained by interpolating based on (1) the pixel x(i−D_hf, j−1) in the previous pixel row (the (j−1)-th row) along the direction D_hf, (2) the pixel x(i+D_hf, j+1) in the next pixel row (the (j+1)-th row) along the direction D_hf, (3) the pixel x(i-D_If, j−1) in a previous pixel row (the (j−1)-th row) along the direction D_If and (4) a pixel x(i+D_If, j+1) in the next pixel row (the (j+1)-th row) along the direction D_If.

A pixel in a high-frequency portion or a disordered portion has a larger SAD″, so that the parameter P_hf(i,j) related to the optimum direction D_hf of the high-frequency portion has a larger weight and the parameter P_If(i,j) related to the optimum direction D_If of the low-frequency portion has a smaller weight. Conversely, the pixel located in a low-frequency portion has a smaller SAD″, so that the parameter P_hf(i,j) related to the optimum direction D_hf of the high-frequency portion has a smaller weight, and the parameter P_If(i,j) related to the optimum direction D_If of the low-frequency portion has a larger weight.

In the embodiment of the disclosure, if the to-be-interpolated pixel is located at an edge, then the edge direction is obtained according to the above disclosure, such that the interpolated pixels are smooth and/or stable even at the object corner and edge intersection.

Since the window width may be adaptively adjusted, the edge direction may thus be predicted and the results obtained at various edges are correct and stable.

The high-frequency portion and the low-frequency portion of an image are identified based on the second order differential of SAD, and stable results in the high-frequency portion of the image are obtained by multi-directional selection.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An image processing method for processing an interleaved image, comprising:
setting a reference window and a plurality of direction windows matched the reference window with respect to a plurality of known pixel rows in the interleaved image;
calculating a plurality of first parameters along all candidate directions of the reference window, wherein the first parameters denote pixel differences between the reference window and the direction windows;
as for each of among a plurality of direction groups of the candidate directions, finding a respective first direction corresponding to a minimum of the first parameters for each direction group;
finding a first portion direction of a first portion and/or a second portion direction of a second portion of the interleaved image among the first directions;
identifying the first and the second portions of the interleaved image according to the first parameters; and
obtaining a center pixel of the reference window by way of interpolation according to the first and the second portion directions.

2. The method according to claim 1, wherein,
the reference window and the direction windows are set according to a shift parameter and a window width parameter, wherein the reference window and the direction windows comprise the same number of known pixels.

3. The method according to claim 2, wherein, the direction windows are obtained by changing the shift parameter and the window width parameter.

4. The method according to claim 3, wherein the first parameter is obtained by summing absolute differences between the known pixels of the reference window and the known pixels of one of the direction windows and then dividing by the window width parameter.

5. The method according to claim 4, wherein:
the candidate directions are grouped into a top right direction group, a top middle direction group, a top left direction group, a bottom right direction group, a bottom middle direction group and a bottom left direction group;
the respective first direction of each direction group, which is corresponding to a minimum first parameter, is found, wherein, a first top right direction of the top right direction group corresponds to a minimum first parameter related to the top right direction group, a first top middle direction of the top middle direction group corresponds to a minimum first parameter related to the top middle direction group, a first top left direction of the top left direction group corresponds to a minimum first parameter related to the top left direction group, a first bottom right direction of the bottom right direction group corresponds to a minimum first parameter related to the bottom right direction group, a first bottom middle direction of the bottom middle direction group corresponds to a minimum first parameter related to the bottom middle direction group, and a first bottom left direction of the bottom left direction group corresponds to a minimum first parameter related to the bottom left direction group.

6. The method according to claim 5, wherein:
the first portion direction corresponding to a minimum first parameter is selected among the first top right direction, the first top middle direction, the first top left direction, the first bottom right direction, the first bottom middle direction and the first bottom left direction.

7. The method according to claim 6, wherein:
the shift parameter d has a minimum first parameter along the second portion direction in the second portion; and
a sum of the first parameters within a range [1,d] along the second portion direction in the second portion is smaller than a sum of the first parameters within other ranges.

8. The method according to claim 7, wherein, the step of finding the second portion direction comprises:
selecting among the first top right direction, the first top middle direction and the first top left direction as a first up direction, which relates to a minimum sum of the first parameters;
selecting among the first bottom right direction, the first bottom middle direction and the first bottom left direction as a first down direction, which relates to a minimum sum of the first parameters; and
selecting among the first up direction and the first down direction as the second portion direction, which relates to a minimum sum of the first parameters.

9. The method according to claim 8, wherein, the step of identifying the first and the second portions of the interleaved image comprises:
identifying the first and the second portions of the interleaved image according to a second order differential of the first parameter.

10. The method according to claim 9, wherein, the step of obtaining the center pixel of the reference window by way of interpolation comprises:
obtaining the center pixel x(i,j) by interpolating a pixel x(i−D_hf, j−1) in a previous pixel row along the second portion direction, a pixel x(i+D_hf, j+1) in a next pixel row along the second portion direction, a pixel x(i−D_If, j−1) in the previous pixel row along the first portion direction and a pixel x(i+D_If, j+1) in the next pixel row along the first portion direction, according to the second order differential of the first parameter and a weighting factor, wherein, i and j respectively denote a horizontal position and a vertical position of the center pixel, D_hf denotes a second portion direction, and D_If denotes a first portion direction.
